(19) United States
(12) Patent Application Publication
(10) Pub. No.: US 2006/0119465 A1
(43) Pub. Date: Jun. 8, 2006

(54) Fuse with expanding solder

(76) Inventor: G. Todd Dietsch, Park Ridge, IL (US)

Correspondence Address: Bell, Boyd & Lloyd LLC, P.O. Box 1135, Chicago, IL, 60690-1135, US

(21) Appl. No.: 11/004,286

(22) Filed: Dec. 3, 2004

(51) Int. Cl. H01H 85/06

(52) U.S. Cl. 337/186

(57) ABSTRACT

An improved electrical component, such as a fuse, is provided. The component or fuse includes an insulative housing and at least one conductive end cap secured to the housing. The end cap is secured to the housing, at least in part, via a solder that expands upon cooling or upon transitioning from a liquid to a solid state. The solder in one embodiment includes bismuth, which provides such expansion qualities. Bismuth also has a relatively high melting temperature and may be used, alone or in combination with other higher melting temperature metals, such as antimony, in applications employing external lead-free solders, which typically have higher melting temperatures than leaded solders.

### BACKGROUND OF THE INVENTION

The present invention relates to circuit protection and more particularly to fuse protection.

Miniature cartridge fuses commonly include a main insulating housing, conductive end caps secured to the housing and a fuse element or wire extending across the end caps. The cup-shaped or open end caps include a skirt portion that extends over the ends of the housing. The fuse element may be electrically and physically secured to the end caps via a body of solder in each of the end caps. The solder can also extend into small clearance spaces between the skirt of the end caps and the insulative housing.

In the past, to prevent the end caps from falling off the housing under normal handling conditions and under short circuit blowout conditions, a shrink sleeve or an encapsulation material has been applied around the housing and the end caps. The encapsulation material adds cost and complexity to the fuse. Other fuses equip the insulative fuse housing with retaining grooves that mate with snap-fitting shoulders of the conductive end caps. Such configuration also adds to the complexity of the fuse. It is desirable to eliminate or reduce the amount of additional apparatus needed to prevent the end caps from falling off the housing under normal handling conditions and upon a short circuit opening of the fuse.

One problem facing surface mount electrical components today is the use or impending use of lead-free solders to secure electrical components to printed circuit boards via either wave or reflow soldering. Lead-free solders have higher melting temperatures than do lead-based solders. Many electrical components, such as certain fuses, include internally soldered joints. A fear is that the lead-free solder requires higher secondary assembling operating temperatures, and that the higher operating temperatures will cause the internal solder joints to melt.

If an internal solder joint melts or becomes semi-liquidous, a wire or other apparatus held in place by the solder joint may loosen or come completely free from the connection. The corresponding component becomes defective. Moreover, a defective component is now fixed to the printed circuit board. That defective component must then be detected, removed and replaced. Accordingly, an additional need exists for electrical components, and in particular fuses, that will not become defective when soldered to a printed circuit at the higher processing temperatures associated with lead-free solders.

### SUMMARY OF THE INVENTION

The present invention provides an improved circuit protection device. In one embodiment the circuit protection device is a fuse, for example, a cartridge fuse. The device is improved in one aspect because it employs a solder that expands upon cooling and transforming from a liquid state to a solid state. Such expansion creates a compressive force between the surfaces it contacts. In one embodiment, such compressive force is between a conductive cap and an insulative housing of the fuse. The compressive force helps to fix the caps to the housing.

The solder in one embodiment is made largely of the element bismuth. Bismuth has a melting temperature of 271° C. At that temperature, solid bismuth has a density of 10.0 kg/dm and liquid bismuth has a density of 9.67 kg/dm. Because solid bismuth is less dense than liquid bismuth, solid bismuth occupies more space or volume for a given mass than does liquid bismuth. The present invention capitalizes on that quality.

As discussed above, fixing a conductive cap to an insulative body can be problematic. The end caps need to be reasonably secured to the insulative housing. The attachment process cannot damage the housing however. Also, the end caps need to be fixed to the housing in such a way that a fuse element located inside the fuse: (i) can be connected electrically thereafter to the end caps or (ii) does not come loose from one or both of the end caps if connected to the one or more end caps before the end caps are secured to the housing.

In one embodiment, the expanding solder of the present invention is pre-plated or pre-placed onto one or both of the insulative housing and the conductive end caps. The end caps may be sized to provide an interference fit with the insulative housing. The insulative housing may also include notches or indents that snap-fit with corresponding tabs or detents placed on the caps. That is, there may be, but does not have to be, additional securing apparatus in addition to the expanding solder of the present invention.

The caps are placed over the insulative housing. The solder is heated, eventually melts, and either is already located between a skirt of the cap and the housing or runs between the skirt and the housing. In either case, when the solder cools and transitions from a liquid state to a solid state, the solder expends and increases the cap retention force or the force required to remove the caps from the housing.

In another aspect, the device is improved because it employs an internal solder having a relatively high melting temperature. The melting temperature is high enough that the internal solder will not melt when the device or fuse is soldered to a printed circuit board (“PCB”) with an external solder that is lead-free (lead-free solders typically require processing temperatures higher than those associated with leaded solders).

The internal solder of the present invention may include additional metals, such as antimony or silver, which raise the overall melting temperature of the solder additionally. Also, the present invention is not limited to bismuth and instead includes any suitable metal that expands upon cooling, such as gallium.

It is therefore an advantage of the present invention to provide an improved electrical device.

It is another advantage of the present invention to provide an improved fuse.

It is another advantage of the present invention to provide a method and apparatus for securing one component of an electrical device to another.

Moreover, it is an advantage of the present invention to provide an electrical component suitable for assembly using an external lead-free solder.

Additional features and advantages of the present invention are described in, and will be apparent from, the following Detailed Description of the Invention and the figures.

### BRIEF DESCRIPTION OF THE FIGURES

FIG. 1 is a perspective view of one embodiment of the fuse having the expanding solder of the present invention.

FIG. 2 is a cross-section of FIG. 1, taken along line II-II, showing the fuse with one type of fuse element.

FIG. 3 is a cross-section of FIG. 1, taken along line III-III, showing the fuse with another type of fuse element.

FIG. 4 is a cross-section of FIG. 1, taken along line IV-IV, showing the fuse with a further type of fuse element.

FIG. 5 is a phase diagram for one preferred solder of the present invention, which includes about 95% bismuth and about 5% antimony.

### DETAILED DESCRIPTION OF THE INVENTION

The present invention provides an improved electrical device, such as a fuse. In one embodiment, the fuse is a so-called “cartridge fuse”, which is a small fuse that is typically surface mounted to a printed circuit board (“PCB”). The smallness of the fuse and the method of its attachment to the PCB create a number of manufacturing and operational issues that have led to the apparatus and method of the present invention. The small size of the fuse makes fixing the end caps to the insulative housing and attaching a fuse element to the end caps somewhat difficult.

The end caps need to be fixed well enough to the housing so that the end caps do not come free during shipping or become unattached from the housing upon a short circuit overload. Further, the end caps are fixed so that the fuse element, if attached to one or more end caps before the end caps are connected to the housing, does not become dislodged or unattached from the one or more end caps.

Still further, that the fuse is typically soldered, e.g., wave or reflow soldered, to a PCB for final assembly mandates that the soldered attachments or joints within the fuse of the present invention cannot melt or become liquidous during the external soldering of the fuse to a PCB. Such a requirement is not as difficult to meet with leaded external solders, which typically have lower melting temperatures in the range of 180 to 186° C. However, the use or the impending use of lead-free solders has fueled more concern about the melting of internal solder joints because lead-free solders have typically higher melting temperature, such as 217 to 221° C. The present invention also provides a solution to the assembly problems that lead-free solders present.

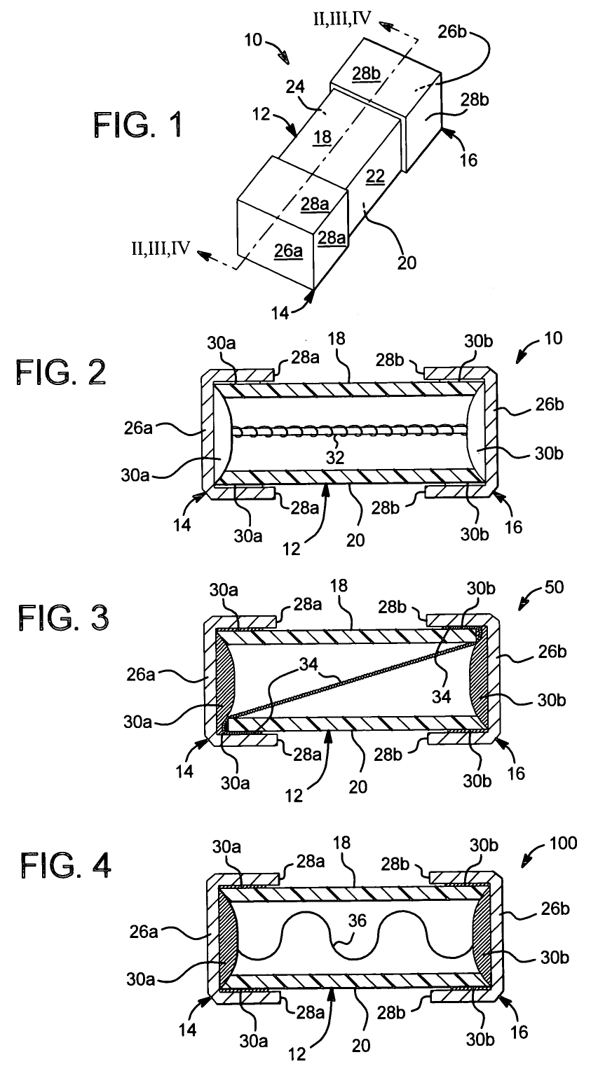

Referring now to the drawings and in particular to FIGS. 1 to 4, the outside of the fuse 10, 50 and 100, shown respectively in the section views of FIGS. 2 to 4, is illustrated. Fuses 10, 50 and 100 include an insulative body 12. A pair of end caps 14 and 16 is fixed to or attached to insulative body 12. Insulative body 12 includes a top 18, a bottom 20, a front 22 and a back 24. As seen in FIGS. 2 to 4, body 12 is open on the ends that are capped off with caps 14 and 16. Body 12 may be made of any suitable insulating material, such as a ceramic material, glass material or a relatively high temperature insulative polymer.

End caps 14 and 16 may be made of any suitable conductive material, such as copper, tin, nickel, gold, silver, brass, gold and any combination thereof. End caps 14 and 16 may include any suitable one or more coatings, such as a nickel, gold, tin silver copper intermediate or finish coating. Further, alloys of the above metals may also be used for the base and plating materials of end caps 14 and 16. Still further, the end caps may not have any plated coatings.

As seen in FIGS. 2 to 4, the insides of fuses 10, 50 and 100 are illustrated. End cap 14 includes an end 26a. A, e.g., four-sided skirt 28a extends from end 26a of cap 14. Cap 16 includes an end 26b and a skirt 28b that extends from end 26b. In an embodiment, caps 14 and 16 are open five-sided structures, with an end and a four-walled skirt extending from the end. In an alternative embodiment, ends 26a and 26b are at least substantially circular and skirts 28a and 28b are at least substantially cylindrical. Other suitable shapes for the end caps, housings and fuses are also within the scope of the present invention.

In one embodiment, end caps 14 and 16 are pre-plated or pre-prepared with the solder of the present invention. In one implementation, an inner surface of the end 26a is plated or pre-prepared with an area of solder 30a. The inner surface of end 26b of cap 16 is plated or pre-prepared with an area of solder 30b. The solder areas 30a and 30b may or may not initially extend to the inner surfaces of skirts 28a and 28b of caps 14 and 16, respectively.

Caps 14 and 16 in one embodiment fit over insulative body 12 so that a small amount of clearance seen in FIGS. 2 to 4 exists between an inner surface of the skirts 28 (referring collectively to skirts 28a and 28b) of end caps 14 and 16 and the outer surfaces of top 18, bottom 20, front 22 and rear 24 of insulative housing 12. Alternatively, skirts 28 are sized such that their inner surfaces create an interference fit with the outer surfaces of housing 12. In such case, the inner surfaces of skirt 28 may be plated or pre-prepared with solder areas 30 (referring collectively to solder areas 30a and 30b) to ensure that solder resides between the caps 14 and 16 and body 12. It should also be appreciated that in an embodiment, the ends of one or more of the top 18, bottom 20, front 22 and back 24 of body 12 may be pre-plated with the solder of the present invention prior to assembly with the caps 14 and 16.

Fuse elements or wires 32, 34 and 36 of fuses 10, 50 and 100, respectively, may be attached electrically to solder areas 30a and 30b and thus to caps 14 and 16 in a variety of ways. In one way, after caps 14 and 16 are placed over housing 12, fuse elements 32 or 36 are fitted through small holes in the relative centers of ends 26a and 26b of caps 14 and 16, respectively. In another embodiment, fuse element 32 or 36 is fixed to one of the caps 14 and 16 and is fused or connected to the other cap 14 or 16 during the soldering process. In still a further embodiment illustrated by the fuse 34 of FIG. 3, fuse element 34 extends diagonally within housing 12 and is bent at both ends around the outside of insulative housing 12 before the end caps 14 and 16 are placed on the housing. The press-fit or soldering process then holds fuse element 34 in place. Fuse element 34 may be used for example with fast opening fuses.

FIGS. 2 to 4 illustrate that fuse elements 32, 34 and 36 have a variety of forms and shapes. Fuse element 32 is a spirally wound conductive wire on an insulative or conductive substrate. Fuse element 34 is a braided or a single strand of wire. Fuse element 36 has a serpentine shape. Any of the above fuse elements may include a core conductive material, such as copper, which is plated for example with tin, gold or silver. The fuse elements can also be coiled or spiral-wound or have any other suitable configuration. In an embodiment, the fuse elements are sized and dimensioned to open or blow upon a certain current or energy threshold.

As described above, end caps 14 and 16 may make an interference fit with body 12. Alternatively or additionally, body 12 may include indents or recesses (not illustrated) that accept tabs or detents (not illustrated) that extend inwardly from the skirts 28 of caps 14 and 16. The tensile force or increase in cap retention capability provided by the expanding solder of the present invention is expressly contemplated to be used in combination with one or more of the above-described additional mechanical attachment devices. The present invention also expressly contemplates not employing those additional mechanical attachment devices and relying instead on (i) the adhesion that the solder areas 30 provide between the housing 12 and end caps 14 and 16 and (ii) the expanding nature of the solder areas 30 of the present invention. When additional apparatuses are negated, complexity of fuses 10, 50 and 100 is reduced.

In an embodiment, after caps 14 and 16 have been placed over housing 12, fuses 10, 50 and 100 are heated to and/or past the melting temperature of solder areas 30. The melted solder can travel through the narrow clearance areas between the inner surfaces of skirts 28 and the outer surfaces of housing 12 via a process called wicking. As the solder cools and hardens it expands, placing a compressive force on the inner surfaces of skirts 28 and the outer surfaces of housing 12. In that manner, the expanded solder and compressive force adds to the cap retention capabilities of the fuses of the present invention.

In another embodiment, the inner surfaces of skirts 28 are pre-plated and press-fit over housing 12. Fuses 10, 50 and 100 are again heated to or above the melting temperature of solder areas 30. The solder areas 30 become liquidous, allowing some of the force of the press fit to be relaxed. When the solder areas 30 are cooled the solder expands and returns the caps 14 and 16 in body 12 to the press-fit state, and wherein the caps 14 and 16 are now adhered to body 12 via the melting and rehardening process. The heating process may help smoothen or even the layer of solder 30 between the skirts and the housing.

The solder of the present invention can include any metal, which has a solid state density at the melting temperature that is lower than the liquid state density at that melting temperature. For example, bismuth is one preferred solder material of the present invention. Bismuth has a melting temperature of 271° C. At this temperature, solid bismuth has a density of 9.67 kg/dm. At this melting temperature, liquid bismuth has a density of 10.0 kg/dm. Keeping in mind the equation for determining density, d=m÷v, the volume occupied by bismuth when in a solid or liquid state is v=m×d. The mass of the solder does not change whether the solder is in a liquid state, solid state or multi-phase state. The mass is constant. Therefore, the volume or space that the solder occupies is greater at 271° C. for solid bismuth than it is for liquid bismuth. In essence, bismuth expands when it transforms from a liquid to a solid state, e.g., when bismuth is cooled. Other metals having such a quality or characteristic include: gallium and antimony.

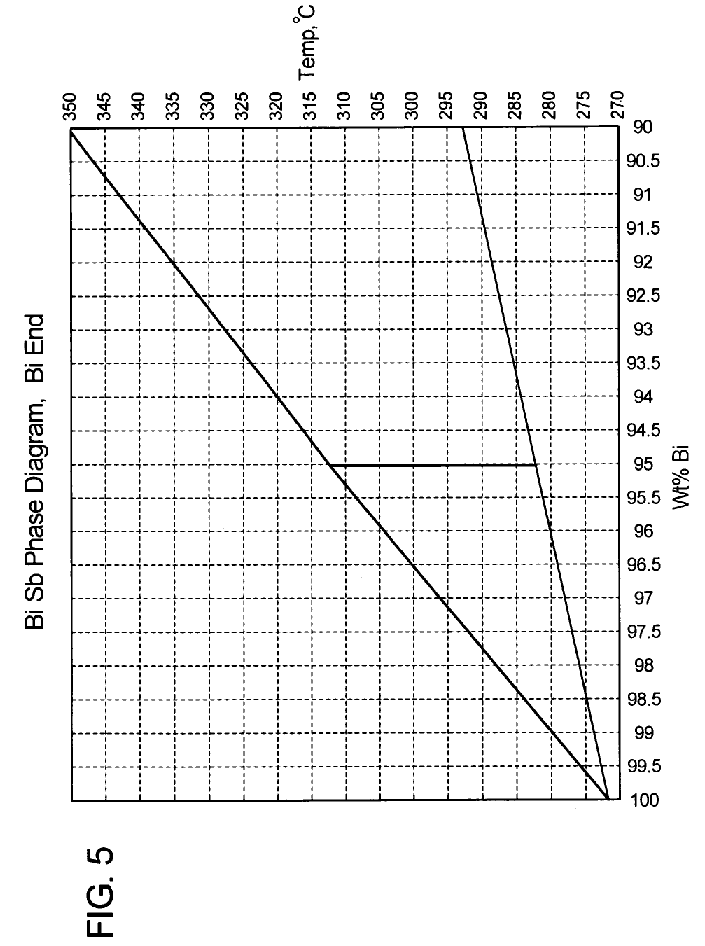

One preferred solder of the present invention includes about 95% bismuth and about 5% antimony. Referring now to FIG. 5, a phase diagram for a bismuth and antimony solder is illustrated. As seen in FIG. 5, at approximately 100% bismuth the temperature at which solder turns from a solid to a liquid and vice-versa is approximately the melting temperature of bismuth, that is, about 271° C. As the percentage of antimony grows from 0 to 10%, two changes occur. First, a lower end of a melting range increases from about 271° C. to about 292° C. Second, a range of temperatures within which the solder melts or is multi-phase increases from about a 0° C. range to about a 58° C. range. Thus, with pure bismuth, the expansion occurs at approximately one temperature, whereas with, for example, 95% bismuth and 5% antimony, the expansion occurs along a range of temperatures from about 282° C. to about 312° C. At 282° C. the solder is substantially solid and expanded fully. At approximately 312° C. or higher the solder is substantially liquid and consumes a smaller volume. In between, the state of the solder is multi-phase and the solder consumes a volume that increases as the temperature drops towards 282° C.

The solder of the present invention provides a second benefit to fuses 10, 50 and 100. As discussed above, and is seen in FIGS. 1 to 4, the fuses in one embodiment are surface mounted or otherwise mounted to a PCB. In the configuration shown in FIGS. 2 to 4, the fuse is typically placed onto pads having a solder paste via a pick and place machine. The PCB carrying the fuse or component is then sent through an oven called a reflow oven. The reflow oven heats the PCB and fuse to a temperature that melts the solder paste upon which fuse 10, 50 or 100 sits. The solder paste melts or reflows as the PCB travels through the oven. Afterward, the PCB and components cool, allowing the solder paste to harden, attaching the component or fuse to the PCB.

In an alternative embodiment, pins or leads extend from end caps 14 or 16. The pins or leads are inserted through holes in the PCB. The board is then sent through a machine called a wave soldering machine, which can have one or two waves or bathes of molten solder. The solder from the bathes wicks up through the holes in the PCB into which the pins are inserted. The solder from the wave soldering machine creates solder joints holding the component to the PCB after the PCB passes over the one or more waves.

Both reflow and wave soldering subject the PCB to relatively intense heating. With reflow soldering the PCB is heated continuously as it passes through the heating oven. With wave soldering, the solder heats the boards and components located on the boards. The wave soldering machines also preheat the PCBs before passing the PCB's over the wave to reduce the temperature shock from the molten solder.

In the past, solder used in reflow paste as well as in the wave solder bathes has included lead. A very common solder is a 63/37 tin to lead solder. The presence of lead causes the melting temperature of the resulting solder to be about 183° C. Recently, due to environmental issues involving the use of leaded solders and the disposal of its dross (product of oxidation), board assemblers have attempted to use lead-free solders. Lead-free solders may consist of pure tin or tin in combination with other metals, such as silver, copper and antimony. The melting temperatures of the lead-free solders are higher. The melting temperatures of lead-free solders are typically about 217° C. to 232° C.

A fear is that as the melting temperature of the external or board assembly solder rises, the likelihood that internal solder areas (such as solder areas 30a and 30b of fuses 10, 50 and 100) may melt or become liquidous upon assembly of the component or fuse to the PCB increases. As can been seen in FIGS. 2 to 4, such a situation may cause the fuse elements 32, 34 or 36 to come loose or be dislodged from end caps 14 and 16. Also, loose liquidous solder can create an inadvertent short circuit. In either case, the component becomes defective. Moreover, the assembly process secures that defective part to the PCB. The defective part must be detected, removed and replaced. It should be appreciated therefore that internal solders need to have higher melting temperatures to withstand the heating of the components during the external soldering of the component to the PCB.

Bismuth has a relatively high melting temperature. The addition of antimony increases the melting temperature even more as seen in FIG. 5. Other additives may be used instead or in addition to antimony, such as silver and other high melting temperature metals. Furthermore, other metals may be added (e.g., up to one percent of the solder) to the solder and components of the present invention to increase the wettability or wickablity of the solder, the resulting strength of the solder joint and oxidation resistance of the solder for example. In one embodiment, the solder uses at least 90% bismuth or other expandable metal. The majority of the remainder of the solder is made up primarily of a melting temperature increasing element, such as antimony or silver. Other combinations of metals and percentages are possible. Furthermore, solder including any appreciable amount of expandable metal, such as bismuth or gallium, can provide the expandable benefit of the component of the present invention. If the solder is used only for that purpose, the amount of bismuth or other expanding solder does not need to be as great.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A fuse comprising:
an insulative housing;
conductive end caps positioned on the insulative housing;
a fuse element in electrical communication with the conductive end caps; and
solder located between the insulative housing and the end caps, the solder expanding upon transitioning from a liquid to a solid state so as to help hold the conductive end caps to the insulative housing.

2. The fuse of claim 1, wherein the insulative housing is made of at least one material of a type selected from the group consisting of: a ceramic material, a glass material and a plastic material.

3. The fuse of claim 1, wherein the fuse element includes a characteristic selected from the groups consisting of, being: (i) braided, (ii) spiral wound, (iii) single stranded, (iv) serpentine shaped, (v) diagonal with respect to the insulative housing and (vi) of a first conductive material at least partially coated with a second conductive material.

4. The fuse of claim 1, wherein the conductive end caps include at least one characteristic selected from the group consisting of, being: (i) five sided, (ii) open-ended, (iii) plated with at least one conductive coating, (iv) sized to make an interference fit with the housing, (v) sized to provide a slight clearance fit with the housing, and (vi) coated at least partially internally with solder prior to assembly.

5. The fuse of claim 1, wherein the solder includes at least one element selected from the group consisting of: bismuth, antimony, silver and gallium.

6. The fuse of claim 1, wherein the solder is lead-free.

7. The fuse of claim 1, wherein the solder includes an element that improves at least one solder characteristic selected from the group consisting of: (i) wettability, (ii) joint strength and (iii) oxidation resistance.

8. The fuse of claim 1, wherein the solder includes at least ninety percent bismuth.

9. The fuse of claim 8, wherein the solder further includes antimony.

10. The fuse of claim 1, wherein the solder has a melting temperature greater than 217° C.

11. The fuse of claim 1, wherein the fuse is a surface mount fuse.

12. A fuse comprising:
an insulative housing;
conductive end caps positioned on the insulative housing;
a fuse element in electrical communication with the conductive end caps; and
solder located between the insulative housing and the end caps, the solder including mostly bismuth.

13. The fuse of claim 12, wherein the solder is secured inside the end caps prior to assembly of the end caps to the insulative housing.

14. The fuse of claim 12, wherein the solder includes at least one additional element selected from the group consisting of: antimony, silver and gallium.

15. The fuse of claim 12, wherein the solder includes a component that improves at least one solder characteristic selected from the group consisting of: (i) wettability, (ii) joint strength and (iii) oxidation resistance.

16. The fuse of claim 12, wherein the solder is a first solder and has a melting temperature greater than a melting temperature of a second solder used to fasten the fuse to a printed circuit board.

17. A method of manufacturing a fuse comprising:
providing an insulative body and end caps sized to house a fuse element; and
enabling solder that expands upon a transition from a liquid state to a solid state to make such transition between the body and the end caps, wherein the expansion provides a force between the end caps and the body.

18. The method of claim 17, which includes engaging the fuse element and the end caps in electrical communication.

19. The method of claim 17, wherein the force is a first holding force and which includes providing a second holding force between the end caps and the body.

20. The method of claim 17, which includes plating at least one of the body and the end caps with the solder prior to enabling the solder expansion.
